(19) United States
(12) Patent Application Publication
(10) Pub. No.: US 2003/0120807 A1
(43) Pub. Date: Jun. 26, 2003

(54) Communication apparatus and communication method

(75) Inventor: Masayoshi Nonomura, Kawasaki (JP)

Correspondence Address: ARMSTRONG,WESTERMAN & HATTORI, LLP, 1725 K STREET, NW, SUITE 1000, WASHINGTON, DC, 20006, US

(73) Assignee: Fujitsu Limited, Kawasaki (JP)

(21) Appl. No.: 10/127,766

(22) Filed: Apr. 23, 2002

(30) Foreign Application Priority Data
Dec. 26, 2001 (JP) 2001-394727

(51) Int. Cl. G06F 15/173

(52) U.S. Cl. 709/238; 709/223

(57) ABSTRACT

A communication apparatus for relaying a host device connected thereto via a transmission line and a plurality of terminals connected thereto via a network is provided which includes relaying means for relaying information received from the host device to the plurality of terminals. The information causes the plurality of terminals to perform predetermined processes. The information contains logic name of a destination terminal. The communication apparatus further includes destination information converting means for replacing the logic name of the destination terminal with a real address of the destination address so that that information containing the real address is transmitted to the destination terminal.

### BACKGROUND OF THE INVENTION

1. Field of the Invention

The present invention relates to a communication apparatus which is connected to a host apparatus via a transmission line and is connected to a plurality of terminal via a network and particularly relates to a communication apparatus and a communication method for relaying the host apparatus and the terminals.

2. Description of the Related Art

10BASE5 cables are commonly used for constructing a LAN (Local Area Network) of a considerably large scale. 10BASE5 is a standardized LAN cable conforming to IEEE 802.3. A 50Ω Thick cable having a bit-rate of 10 Mbps, a diameter of about 12 mm and a maximum segment length of 500 meters is used for 10BASE5. In addition to 10BASE5, LAN cables such as 10BASE2, 10BASE-T and 100BASE-T are known in the art. 10BASE2 is a LAN cable that is a 50Ω Thin cable having a diameter of about 5 mm and has a bit-rate of 10 Mbps and a maximum segment length of 185 meters. 10BASE-T also has a bit-rate of 10 Mbps and uses an unshielded twisted pair cable (UTP) and has a maximum segment length of 100 meters.

Terminals to be connected via LAN have addresses that can be uniquely identified in a LAN environment. Such addresses may be IP (Internet Protocol) addresses and MAC (Media Access Control) addresses.

A plurality of terminals may be connected by a communication cable without using destination addresses. Such a connection method can be achieved using coaxial cables. An example of a coaxial cable is a cable having an impedance of 75Ω and a maximum segment length of 1500 meters. The coaxial cable has a longer maximum segment length and therefore can be connected to a remote terminal by only one coaxial cable. Further, according to the connection method using the coaxial cable, a counterpart that is physically or electrically connected is recognized as a destination terminal. Therefore, the connection method using the coaxial cable does not require an address management function and, therefore, is highly reliable.

An advantageous network environment can be constructed using LAN cables such as 10BASE-T together with a coaxial cable. In order to provide an interface between such two different types of cables or to extend communication distance, it is known to provide a communication apparatus for connecting the cables.

FIG. 1 is a diagram showing how a communication apparatus may be connected. In FIG. 1, a communication apparatus 10 is connected to a host computer 12 in a one-to-one relationship by means of a coaxial cable. On the other hand, the communication apparatus 10 is connected to a terminal 14 by means of a cable such as 10BASE-T. In this example, the terminal 14 is intended to be a printer or a monitor.

The communication apparatus 10, the host computer 12 and the terminal 14 each have an address used for communications between each other. As has been described above, the addresses may be IP addresses or MAC addresses in case where LAN cables are used (e.g., 10BASE-T and 10BASE5). In case of a one-to-one connection using a coaxial cable, addresses are not required. Therefore, in a structure shown in FIG. 1, those elements having addresses are only the communication apparatus 10 and the terminal 14.

A plurality of logic terminals are defined on the terminal 14 such that the terminal 14 virtually serves as a plurality of terminals. In the example shown in FIG. 1, four logic terminals DspA-DspD are defined in the terminal 14. FIGS. 2 and 3 are data format used for exchanging data between the logic terminals Dspa-DspD and the host computer 12. FIG. 2 shows a data format 16 used for exchanging data between the host computer 12 and the communication apparatus 10. The data format 16 has a sub-address which is a logic terminal number and a real data which contains commands and data of the terminal. FIG. 3 is a data format 16 used for exchanging data between the communication terminal 10 and the terminal 14. The data format 18 has areas for storing a sender address, a destination address, a sub-address and real data. The sender address and the destination address are the addresses described above. When relaying the host computer 12 and the terminal 14, the communication apparatus 10 attaches and removes the addresses of those data formats on the basis of the logic terminal numbers and the destinations.

FIGS. 4 and 5 are diagrams showing how data is actually stored in such data formats. FIG. 4 shows a transmission data 20 transmitted from the host computer 12 to the communication apparatus 10 and a transmission data 22 from the communication apparatus 10 to the terminal 14. The transmission data 20 and 22 are both data to be sent to the logic terminal DspA. Therefore, the address DspA is stored in the sub-address storing area shown in FIGS. 2 and 3. In the transmission data 22, an address AdrZ of the communication device 10, which is sending data, is stored in the sending address storage area and an address AdrA of the terminal 14, which is a destination of the data, is stored in the destination address storage area.

FIG. 5 shows a transmission data 24 from the terminal 14 to the communication apparatus 10 and a transmission data 26 from the communication apparatus 10 to the host computer 12. These data are data sent when the terminal 14 regarded as the logic terminal DspD. Therefore, the address DspD of the logic terminal DspD is stored in the sub-address storage area of both of the transmission data 24 and 26. In the transmission data 24, an address AdrA of the terminal 14, which is sending data, is stored in the sending address storage area and an address AdrZ of the communication apparatus 10, which is a destination of the data, is stored in the destination address storage area.

Using the data formats described above, the communication apparatus 10 relays between the host computer 12 and the terminal 14.

However, with such an environment including a host computer and a single terminal that are connected via a coaxial cable, even though a single terminal is logically handled as a plurality of terminals, it is difficult to improve a processing efficiency since there is only one physical terminal. Also, with such an environment with only one terminal, no process can be performed in case of a failure of the terminal.

### SUMMARY OF THE INVENTION

Accordingly, it is a general object of the present invention to provide a communication apparatus and a communication method that can obviate the problems described above.

It is another and more specific object of the present invention to provide a communication apparatus and a communication method for relaying a host device connected via a communication line and a plurality of terminals physically connected via a network which can efficiently perform process of the plurality of terminals by management of status of the terminals and failures of the terminals.

In order to achieve the above objects, the communication apparatus for relaying a host device and a plurality of terminals includes:

first connection means which can be connected to the host device via a transmission line;

second connection means which can be connected to the plurality of terminals via a network; and

relaying means for relaying information received from the host device to the plurality of terminals, the information causing the plurality of terminals to perform predetermined processes.

With the communication apparatus described above, the host device can transmit information for causing the plurality of terminals to perform predetermined processes. Therefore, predetermined processes can be performed in parallel by the plurality of terminals by an instruction from the host device.

According to another embodiment of the present invention, the information contains first destination information designating a destination terminal of the information and the communication apparatus further includes destination information converting means for replacing first destination information with second destination information so that that information containing the second destination information is transmitted to the destination terminal.

Accordingly, since the communication apparatus is provided with the destination information converting means, it is not necessary for the host device to store destination information of the destination terminals.

A communication method for relaying a host device and a plurality of terminals is also provided which includes the steps of:

a) establishing a connection with the host device via a communication line;

b) establishing a connection with the plurality of terminals via a network; and

c) relaying information received from the host device to the plurality of terminals, the information causing the plurality of terminals to perform predetermined processes.

With the communication method described above, the host device can transmit information for causing the plurality of terminals to perform predetermined processes. Therefore, predetermined processes can be performed in parallel by the plurality of terminals by an instruction from the host device.

### BRIEF DESCRIPTION OF THE DRAWINGS

FIG. 1 is a diagram showing how a communication apparatus is connected in the related art.

FIG. 2 is a diagram showing a data format which is communicated between a host computer and a communication apparatus.

FIG. 3 is a diagram showing a data format which is communicated between a communication apparatus and a terminal.

FIG. 4 is a diagram showing data transmitted from a host computer to a communication apparatus and data transmitted from a communication apparatus to a terminal.

FIG. 5 is a diagram showing data transmitted from a terminal to a communication apparatus and data transmitted from a communication apparatus to a host computer

FIG. 6 is a system configuration diagram including a communication apparatus of an embodiment of the present invention.

FIG. 7 is a system configuration diagram with addresses being indicated.

FIG. 8 is a hardware block diagram of the host computer.

FIG. 9 is a hardware block diagram of the communication apparatus.

FIG. 10 is a software block diagram of the communication apparatus.

FIG. 11 is a hardware block diagram of the terminal.

FIG. 12 shows a destination conversion table of the present invention.

FIG. 13 is a system configuration diagram including a communication apparatus of an embodiment of the present invention provided with an alternative terminal.

FIG. 14 shows a destination conversion table including alternative terminal address.

FIG. 15 is a diagram showing a chart of settings.

FIG. 16 is a flowchart of a process performed on settings.

FIG. 17 is a flowchart of a process performed by the communication apparatus when data from a host device is relayed to a terminal.

FIG. 18 is a flowchart of a process performed by the communication apparatus when data from a terminal is relayed to a host device.

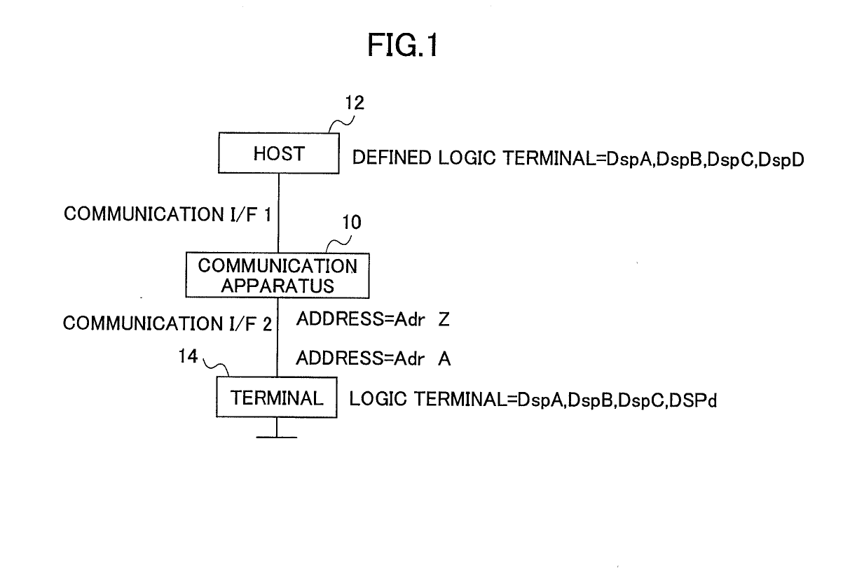

### DETAILED DESCRIPTION OF THE PREFERRED EMBODIMENTS

In the following, principles and embodiments of the present invention will be described with reference to the accompanying drawings.

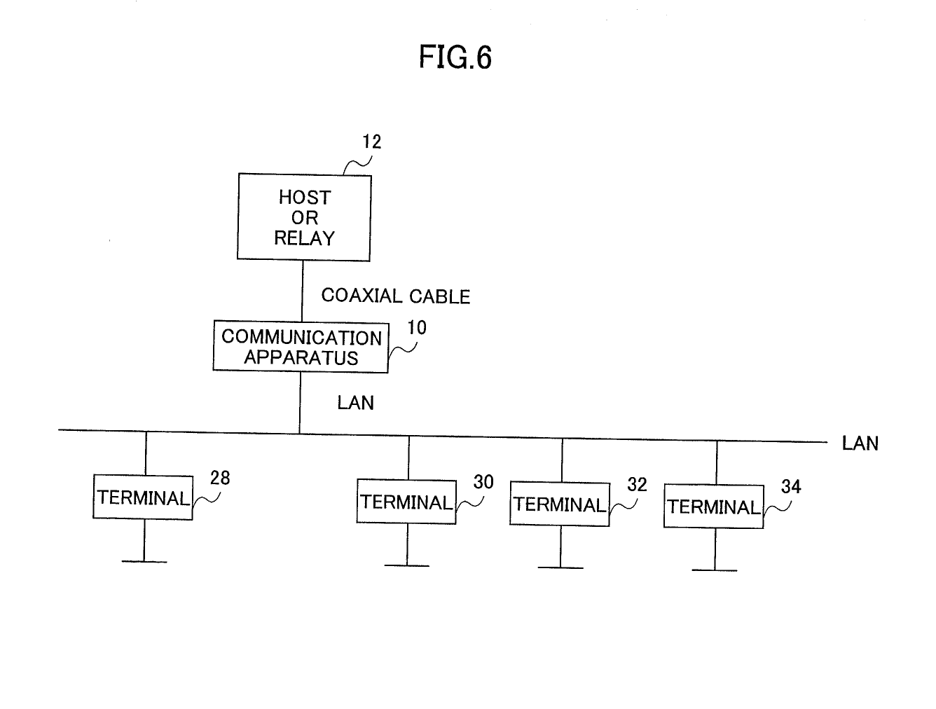

FIG. 6 is a diagram showing a system configuration including a communication apparatus 10 of an embodiment of the present invention whereto a host computer 12 and a plurality of terminals 28, 30, 32 and 34 are connected. It is to be noted that four terminals are illustrated in the figure, but any number of terminals may be connected to the system. In FIG. 6, the host computer 12 and the communication apparatus 10 are connected via a coaxial cable and the communication apparatus 10 and the terminals 28, 30, 32 and 34 are connected via LAN. The communication apparatus 10 relays communications between the host computer 12 and the terminals 28, 30, 32 and 34. The terminal may be a monitor serving as a display device or a printer.

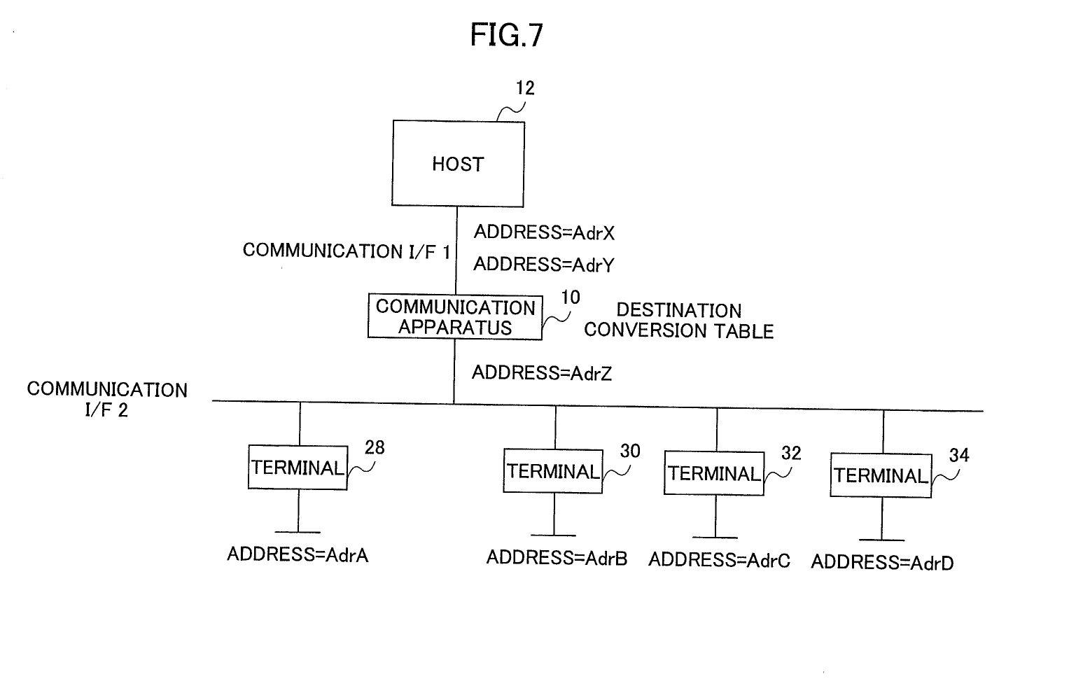

FIG. 7 is a diagram of the system configuration as shown in FIG. 6 accompanied by addresses for the communication apparatus 10, the host computer 12 and the terminals 28, 30, 32 and 34. As shown in FIG. 7, the communication apparatus 10 has an address AdrZ that is used for establishing a connection with LAN. The terminals 28, 30, 32 and 34 have IP addresses or MAC addresses, AdrA, AdrB, AdrC and AdrD, respectively. In this embodiment, no address is required for a connection between the host computer 12 and the communication apparatus 10, since the connection is a one-to-one connection via a coaxial cable. If a connection between the host computer 12 and the communication apparatus 10 is not via a coaxial cable, the host computer 12 is allotted an address AdrX and the communication apparatus 10 is allotted an address AdrY for communicating with the host computer 12.

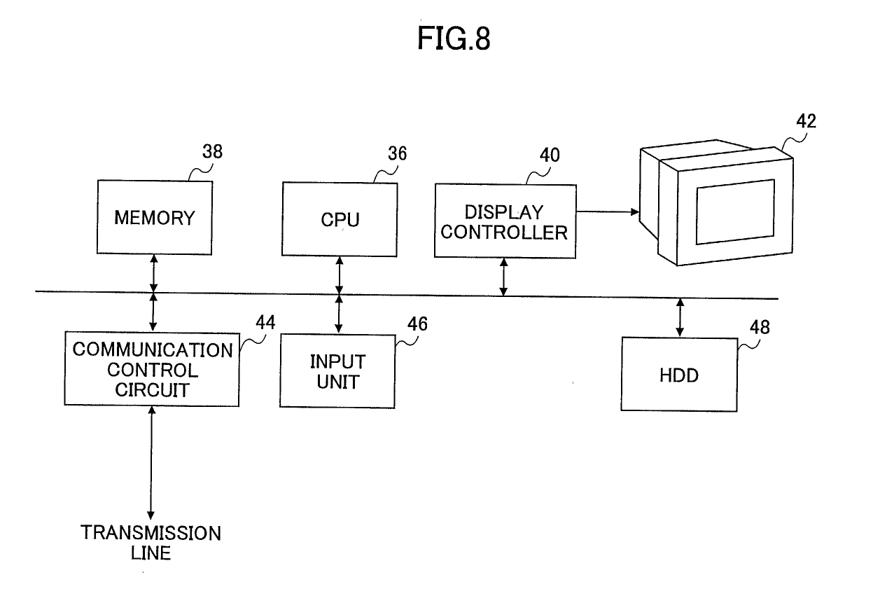

FIG. 8 is a hardware block diagram of the host computer 12. As shown in FIG. 8, the host computer 12 includes a CPU (Central Processing Unit) 36, a memory 38, a display controller 40, a display 42, a communication control circuit 44, an input unit 46 and a HDD (Hard Disk Drive) 48, which are connected via a bus. The CPU 36 follows instructions of a program to execute processes. The memory 38 includes a RAM (Random Access Memory) and a ROM (Read Only Memory). The memory 38 may store BIOS (Basic Input/Output System) and may be used as a work storage area for a program. The HDD 48 stores program and data. The display controller 40 controls a displaying operation of the display 42. The display 42 may be a CRT (Cathode-Ray Tube).

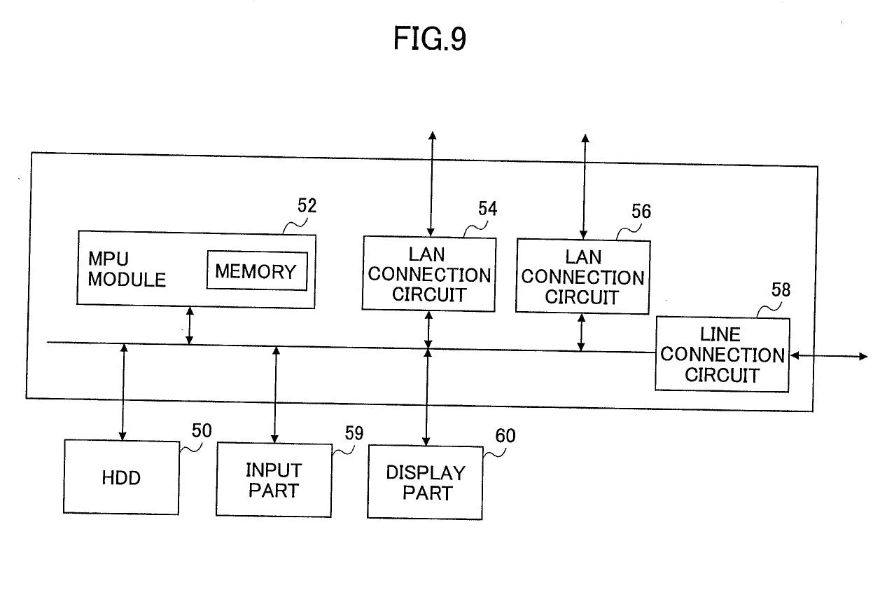

FIG. 9 is a hardware block diagram of the communication apparatus 10. As shown in FIG. 9, the communication apparatus 10 includes an MPU (MicroProcessing Unit) module 52, a LAN connection circuit 54, 56, a line connection circuit 58, an HDD 50, an input part 59 and a display part 60, which are connected via a bus. The MPU module 52 includes a CPU and a memory and executes processes for a relaying operation in accordance with a program. Such a program is stored in the HDD 50. The display part 60, for example, includes LEDs and displays operational statuses such as “error”, “connection” and “READY”. The LAN connection circuits 54 and 56 are circuits for communicating data on LAN and the line connection circuit 58 is a circuit for communicating data between the communication circuit 10 and the host computer 12.

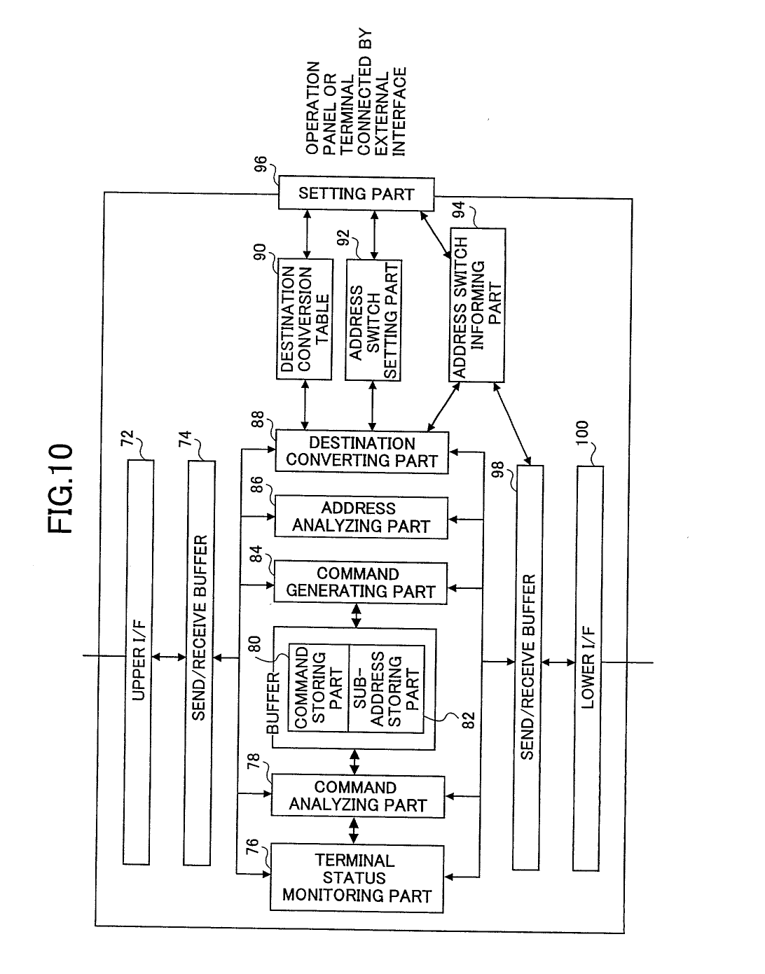

FIG. 10 is a software block diagram of the communication apparatus 10. The communication apparatus 10 includes an upper interface (I/F) 72, a lower interface (I/F) 100, send/receive buffers 74, 98, a terminal status monitoring part 76, a command analyzing part 78, a command storing part 80, a sub-address storing part 82, a command generating part 84, an address analyzing part 86, an address converting part 88, a destination conversion table 90, an address switch setting part 92, an address switch informing part 94 and a setting part 96.

Each block will be described in detail. The upper I/F 72 is an interface to the host computer 12 and the lower I/F 100 is an interface to LAN. The send/receive buffers 74 and 98 buffer data received at the upper I/F 72 and the lower I/F 100, respectively. The terminal status monitoring part 76 monitors communication statuses of the terminals 28, 30, 32 and 34. The command analyzing part 78 analyzes a content of a command to determine, for example, whether the received command is normal. The command storing part 80 stores the received command and the sub-address storing part 82 stores a sub-address. The command generating part 84 converts the received commands into commands for the destination and generates commands to be transmitted by the communication apparatus 10. The address analyzing part 86 checks and analyzes addresses of senders and destinations. The address converting part 88 converts addresses in accordance with the destination conversion table 90 described below. The destination conversion table 90 converts the address of a logic terminal designated by the host computer 12 to a real address of the terminal. The address switch setting part 92 determines whether to switch an address of a particular terminal to an alternative terminal described below. The address switch informing part 94 generates data to be sent to a manager terminal described below to inform that the address has been switched. The destination conversion table 90, the address switching part 92 and the address switch informing part 96 are set by operating a terminal connected to an operation panel or an external interface described below.

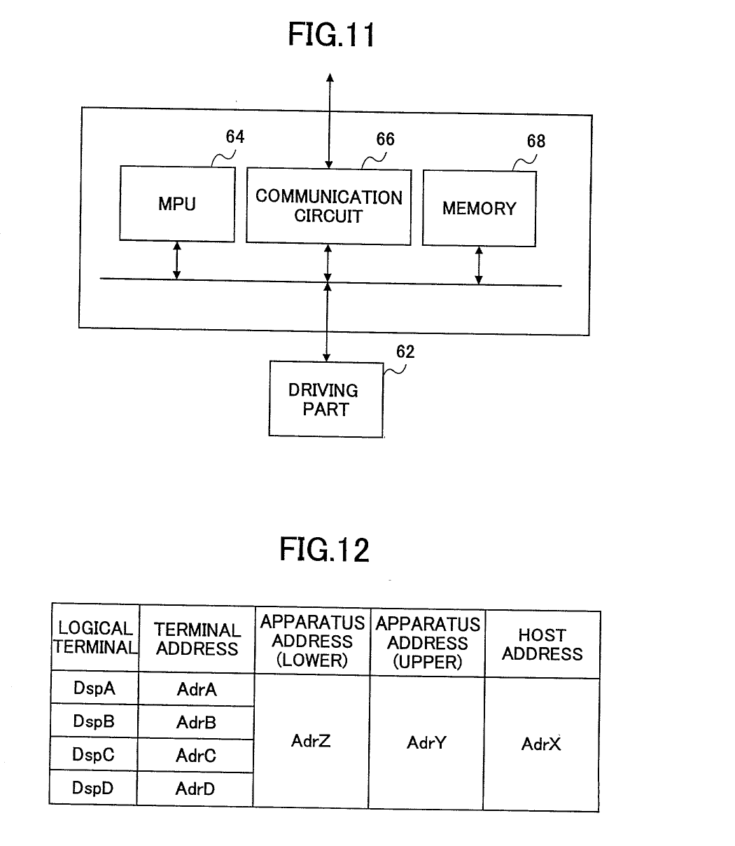

FIG. 11 is a hardware block diagram of the terminals 28, 30, 32 and 34. In the present embodiment, the terminals 28, 30, 32 and 34 are considered as printers. Therefore, as shown in FIG. 11, the terminals 28, 30, 32 and 34 includes a MPU 64, a communication circuit 66, a memory 68 and a driving part 62, which are connected via a bus. The MPU 64 operates in accordance with a program stored in the memory 68 and controls the driving part 62 in accordance with data received by the communication circuit 66. The communication circuit 66 is a circuit for communicating data over LAN.

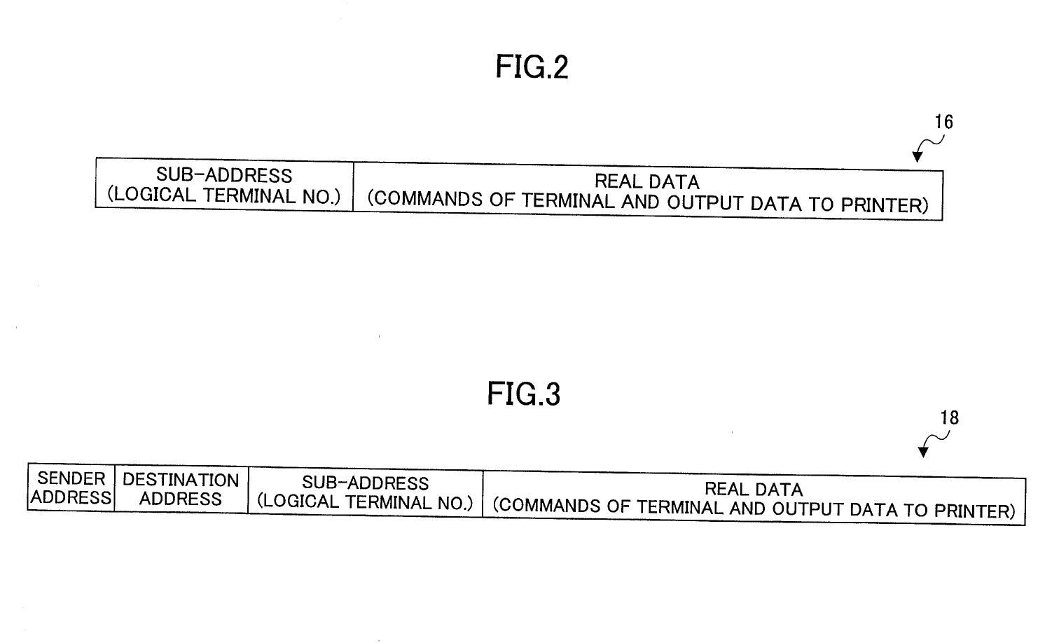

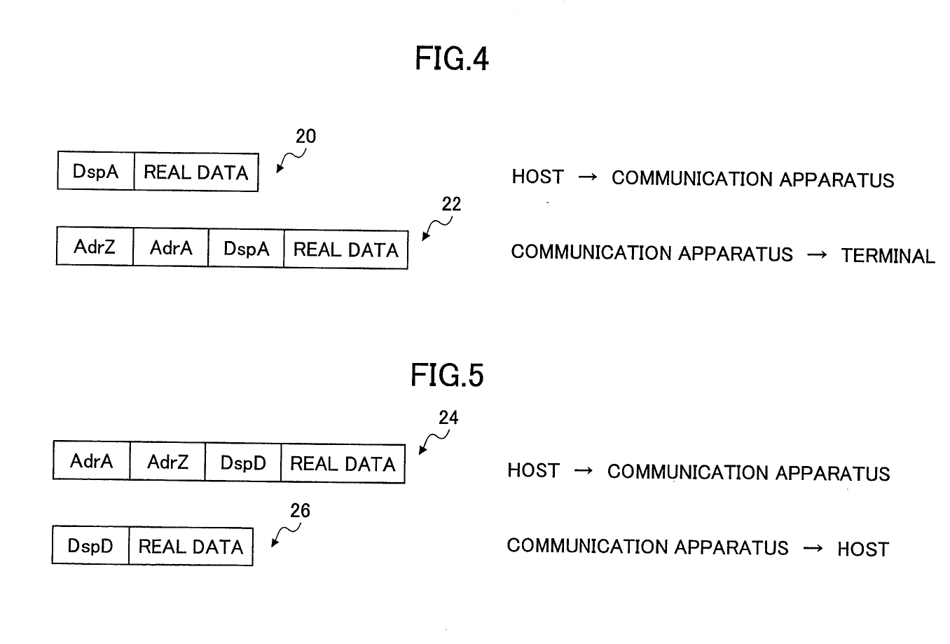

Based on the system configuration described above, data communicated between the communication apparatus 10, the host computer 12 and the terminals 28, 30, 32 and 34 will be described in detail. Data communicated between the communication apparatus 10, the host computer 12 and the terminals 28, 30, 32 and 34 have the formats and contents as illustrated in FIGS. 2 through 5. As shown in FIGS. 2 through 5, the data format of the data communicated between the host computer 12 and the communication apparatus 10 and the data format of the data communicated between the communication apparatus 10 and the terminals 28, 30, 32, 34 are different. A method of converting data format used when the communication apparatus 10 transmits data received from the host computer 12 to the terminals 28, 30, 32, 34 and a method of converting data format used when the communication apparatus 10 transmits data received from the terminals 28, 30, 32, 34 to the host computer 12 will be described below.

FIG. 12 shows a destination conversion table. The communication apparatus 10 refers to the destination conversion table upon data format conversion. The destination conversion table includes five items: Logic Terminal, Terminal Address, Apparatus Address (Lower), Apparatus Address (Upper) and Host Address. Logic Terminal represents the terminals 28, 30, 32, 34. For example, “DpsA” represents the terminal 28 (see FIG. 7). Terminal Address represents addresses of the terminals 28, 30, 32, 34. Apparatus Address (Lower) represents an address of the communication apparatus 10 that is used to connect to LAN and Apparatus Address (Upper) represents an address of the communication apparatus 10 that is used to connect to the host computer 12. Host Address represents an address of the host computer 12. It is to be noted that Apparatus Address (Upper) and Host Address is not required in case where a coaxial cable is used.

Accordingly, using a table that links the logic names and real addresses of the terminals, the communication 10 can send data from the host computer 12 to the destination terminals. It is also possible for the communication apparatus 10 to receive data from the terminals and add logic terminal number to the data to be transmitted so that the host computer 12 can distinguish from which terminal the data has been transmitted.

An alternative terminal will be described in detail. An alternative terminal is such a terminal that takes over the processes to be executed by, for example, the terminal 28 in case of a failure of the terminal 28 in FIG. 7. The alternative terminal may be provided as a dedicated alternative terminal that is prepared in advance or the neighboring terminal 30.

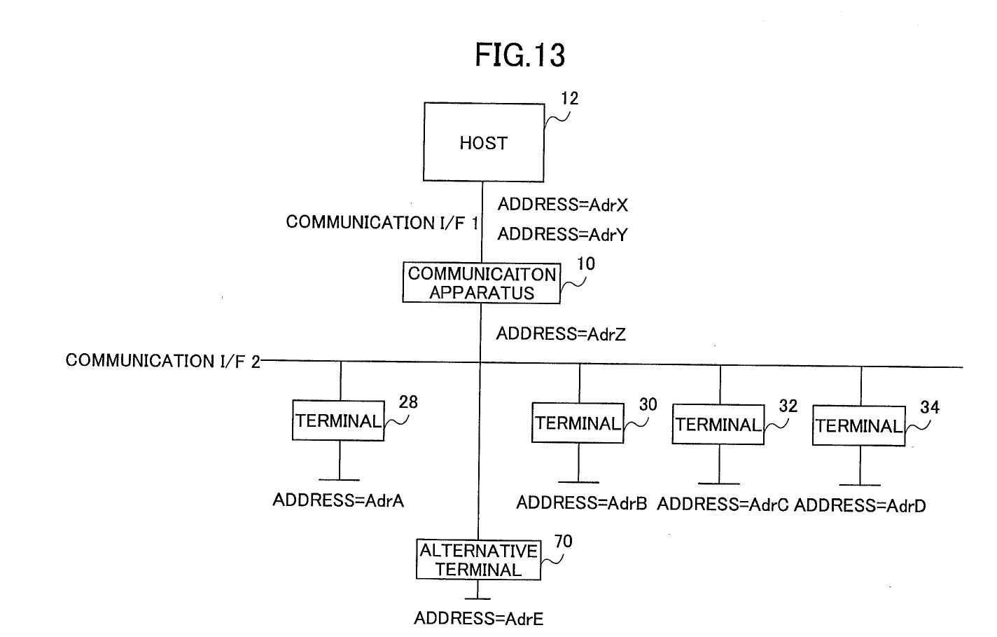

FIG. 13 is a diagram showing a system configuration with a dedicated alternative terminal being provided in advance. The system configuration of FIG. 13 is similar to that shown in FIG. 7 except that the alternative terminal 70 having an address AdrE is added. Further, an alternative terminal for the terminal 30 is also provided which is the neighboring terminal 32 in the illustrated embodiment. Accordingly, in a system shown in FIG. 13, the alternative terminal 70 serves as an alternative terminal of the terminal 28 and the terminal 30 serves as an alternative terminal of the terminal 32.

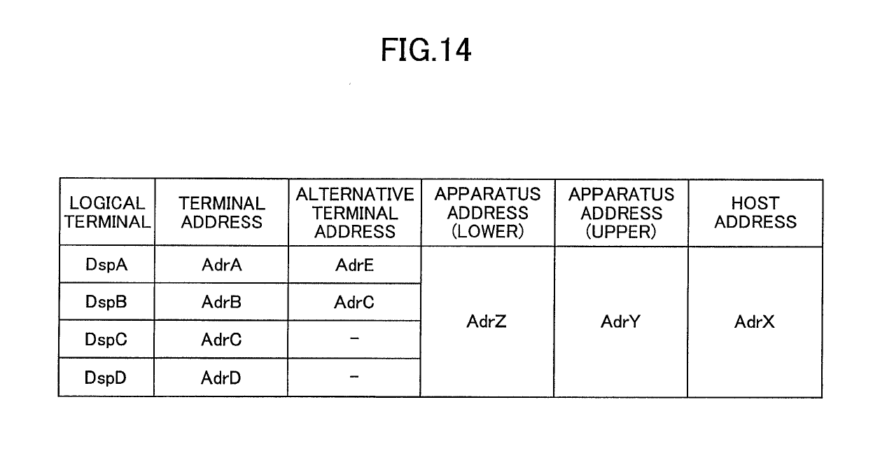

FIG. 14 shows a destination conversion table of the communication apparatus 10 in which an item related to an alternative terminal address is added. In FIG. 14, Alternative Terminal Address of the logic terminal DspA is selected as address AdrE that indicates the alternative terminal 70. Similarly, Alternative Terminal Address of the logic terminal DspB representing the terminal 30 is selected as an address AdrC of the terminal 32. In case of a failure of the terminals, the communication apparatus 10 switched the destination of information such as process request from the host computer 12 to the alternative terminals using the destination conversion table.

Settings of the alternative terminal and other settings for the communication apparatus 10 are set in the following manner. The settings may be set via an operation panel provided on the communication apparatus 10 or via a console terminal connected to an external interface such as a serial port of the communication apparatus 10. The settings may also be set by means of a terminal connected to the communication apparatus 10 via LAN.

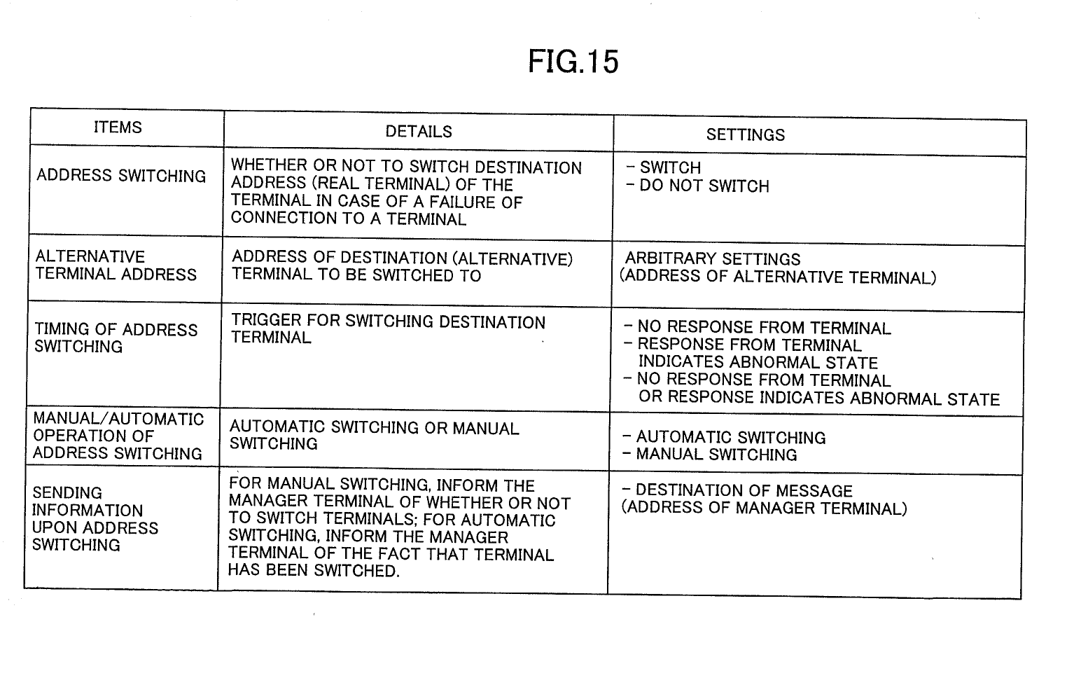

The details of the settings will be described with reference to FIG. 15 showing a chart of the settings. The chart includes: items, details and settings. The following description is made for each item. “ADDRESS SWITCHING” relates to the above-mentioned alternative terminal and determines, in case of a failure to a terminal, whether or not to switch the address to another terminal. Therefore, the item “ADDRESS SWITCHING” determines whether “to switch” or “not to switch”. The item “ALTERNATIVE TERMINAL ADDRESS” specifies the address of the alternative terminal to be switched to. The item “TIMING OF ADDRESS SWITCHING” specifies at which timing the switching operation to the alternative terminal is to be performed and therefore specifies the trigger for performing the switching operation. The switching operation is performed when the alternative terminal is in an abnormal state, that is to say, “NO RESPONSE FROM TERMINAL” and “RESPONSE FROM TERMINAL IS ABNORMAL”. Accordingly, the item “TIMING OF ADDRESS SWITCHING” may be selected as “NO RESPONSE FROM TERMINAL”, “RESPONSE FROM TERMINAL IS ABNORMAL” and “NO RESPONSE FROM TERMINAL OR RESPONSE FROM TERMINAL IS ABNORMAL”.

Further, a selection can be made between an automatic switching operation or a manual switching operation, and this is specified in the item “MANUAL/AUTOMATIC OPERATION OF SWITCHING OPERATION”. For manual switching, if any failure of the alternative terminal is detected, a selection dialog screen “SWITCH TO ALTERNATIVE TERMINAL? (YES/NO)” is displayed on the operation panel so that the user can manually select “YES/NO”. If the terminal displaying such a selection dialog screen is connected to LAN, the communication apparatus 10 should know addresses of the terminals connected via LAN. This is specified in “SENDING INFORMATION UPON ADDRESS SWITCHING”. When an address is specified in this item, the above-mentioned selection dialog or an information screen for informing that the terminal has been automatically switched is displayed on the terminal having the specified address.

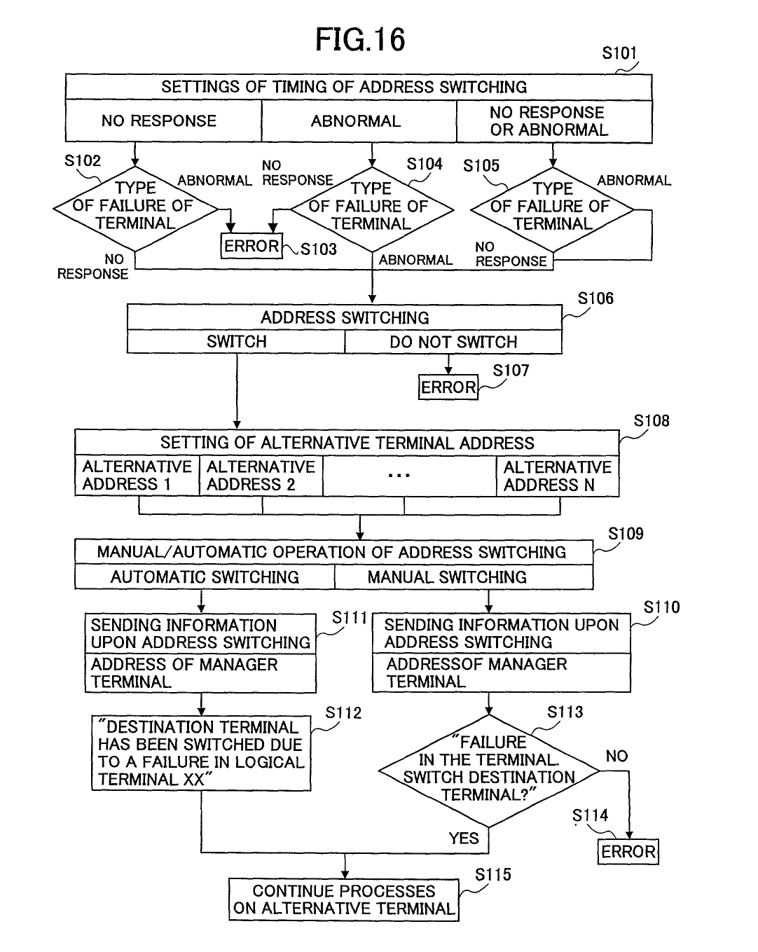

FIG. 16 is a flowchart showing how an address is switched from a terminal with a failure to an alternative terminal. Step S101 branches in three branches according to the settings of the above-described “TIMING OF ADDRESS SWITCHING”. When the setting is “NO RESPONSE”, the process proceeds to step S102. In step S102, the type of failure of the terminal is detected. If the detected failure is a no response state, the process proceeds to step S106 where an address switching operation is performed. If the detected failure is a response indicating an abnormal operation, an error handling operation is performed in step S103. When the setting is “ABNORMAL”, the process proceeds to step S104. In step S104, the type of failure of the terminal is detected. If the detected failure is a response indicating an abnormal operation, the process proceeds to step S106 where an address switching operation is performed. If the detected failure is a no response state, an error handling operation is performed in step S103. When the setting is “NO RESPONSE OR ABNORMAL”, the process proceeds to step S105. In step S105, the type of failure of the terminal is detected. If the detected failure is a no response state or a response indicating an abnormal operation, the process proceeds to step S106 where an address switching operation is performed.

Step S106 branches according to the settings in “ADDRESS SWITCHING”. If the setting is “SWITCH”, the process proceeds to step S108. If the setting is “DO NOT SWITCH”, the process proceeds to step S107 where an error handling operation is performed.

In step S108, an address of an alternative terminal is obtained from the table of alternative address that is set in the “ALTERNATIVE TERMINAL ADDRESS” settings. Step S109 branches according to the settings of “MANUAL/AUTOMATIC OPERATION OF ADDRESS SWITCHING”. If the setting is “AUTOMATIC SWITCHING”, the process proceeds to steps S111 to obtain an address of a manager terminal. In step S112, a message “Destination terminal has been switched due to a failure in logic terminal XX” is displayed on the manager terminal. In step S115, destination terminal is switched to an alternative terminal so that the use can continue his work using the alternative terminal. Referring again to Step S109, when the setting is “MANUAL SWITCHING”, an address a manager terminal is obtained in step S110. In step S113, a message “Failure in the terminal. Switch destination terminal?” is displayed on the manager terminal. If the choice for this message is “NO”, the process proceeds to step S114 where an error handling operation is performed. If the choice for this message is “YES”, the process proceeds to step S115 where destination terminal is switched to an alternative terminal so that the use can continue his work using the alternative terminal.

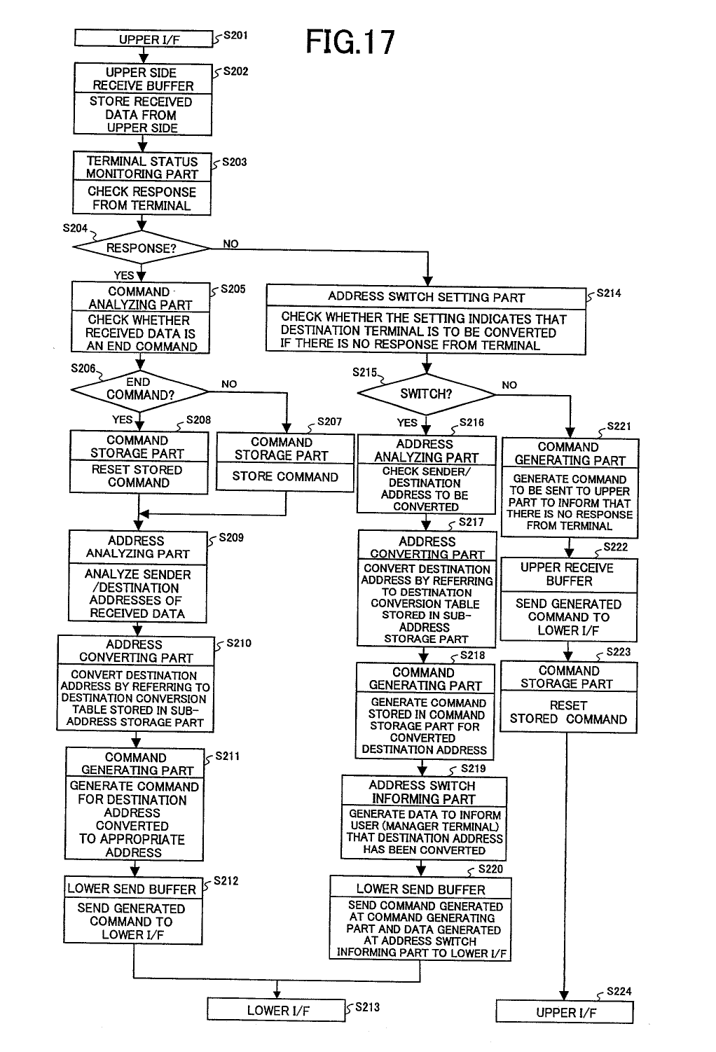

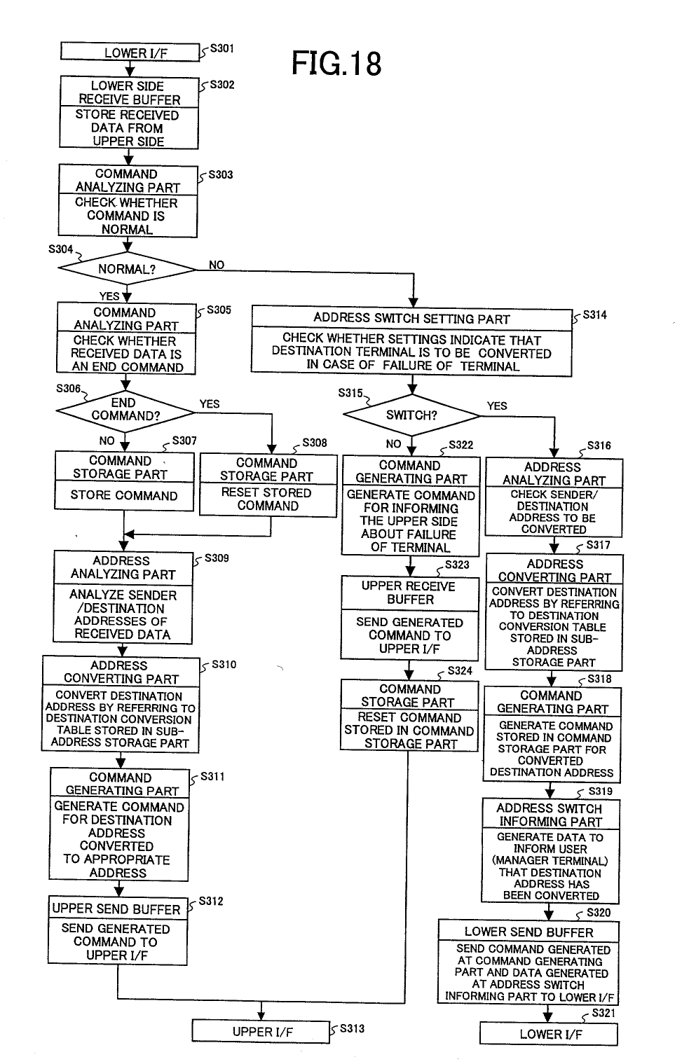

Referring now to FIGS. 17 and 18, processes performed on the communication apparatus 10 will be described. In the following description, elements of the system are described using the reference numerals indicated in FIG. 10.

FIG. 17 is a flowchart showing a process for transmitting data from the host computer 12 to a destination terminal. Initially, in step S201, data from the host computer 12 is received via the upper I/F 72. In step S202, the received data is stored in a send/receive buffer 74. In step S203, the terminal status monitoring part 76 detects a response from the terminal. Step S204 branches the process in accordance with the result of detection in step S203. If the result of detection shows that there is a response from the terminal, the process proceeds to step S205 where the command analyzing part 78 determines whether a command received from the host computer 12 is an end command. In step S206, if it is determined as an end command, the command stored in step S208 is reset and if it is not the end command, the received command is stored in step S207. In step S209, the address analyzing part 86 analyzes address of the sender and destination of the received data. In step S210, the address converting part 88 converts the destination address by referring to an address table stored in the sub-address storage part. In step S211, the command generating part 84 generates commands to be sent to the destination address that has been converted to an appropriate address. In step S212, the lower send buffer 98 sends the generated command to the lower I/F 100 and the command is output on LAN via the lower I/F 100.

If the result step shows that there is no response from the terminal, the following steps are performed. When there is no response from the terminal, the address switch setting part 92 detects in step S214 whether the setting is set such that the destination is converted when there is no response from the terminal. In step S215, the result of the detection is determined. If the setting indicates that the destination terminal is not to be converted, in step S221, the command generating part 84 generates commands for informing to an upper side that there is no response from the terminal. In step S222, the upper send/receive buffer 74 sends the command to the upper I/F 72. In step S224, the upper I/F sends the command to the host computer 12. In step S223, the command storage part 80 resets the command stored therein.

If it is determined in step S215 that an address converting operation is required, the process proceeds to step S216. In step S216, the address analyzing part 86 checks the sender address and the destination address to be converted to. In step S217, the address converting part 88 converts the destination address by referring to the address table stored in the sub-address storage part 82. In step S218, the command generating part 84 generates commands stored in the command storage part 80. In step S219, the address switching informing part 94 generates address convert informing data which informs the manager terminal that the destination address has been converted. In step S220, the send/receive buffer 98 sends the generated command and the address convert informing data to the lower I/F 100. In step S213, these data are transmitted on LAN from the lower I/F 100.

As has been described above, data from the host computer 12 is transmitted to the terminal with the address being converted by the communication apparatus 10. In case of a failure of the terminal the communication apparatus 10 further performs processes such as transmitting data to an alternative terminal and informing the host computer 12 that the terminal has failed.

Referring to FIG. 18, a process of transmitting data received from the terminal to the host computer will be described. In step S301, data is received at the lower I/F 100 which is provided for receiving data from the terminal. In step S302, the received data is stored in the send/receive buffer 98. In step S303, the command analyzing part 84 determines whether the data is a normal data. Based on the result of step S303, the process is branched in step S304. If the data is a normal data, the process proceeds to step S305 where the command analyzing part 78 determines whether the data is an end command. If the data is not an end command, in step S307, the command storage part 80 stores the command. If the data is an end command, in step S308, the stored command is reset. In step S309, the address analyzing part 88 analyzes the sender address and the destination address of the received data. In step S310, the address converting part 88 converts the destination address by referring to the address table stored in the sub-address storage part 82. In step S311, the command generating part 84 generates a command for the destination address that has been converted to an appropriate address. In step S312, the send/receive buffer 74 sends the generated command to the upper I/F 72. In step S313, the command is transmitted from the upper I/F to the host computer 12.

Referring again to step S304, if the command from the terminal is abnormal, the following processes are performed. If the command is abnormal, in step S314, the address switch setting part 92 verifies whether the setting indicates that the terminal is converted to the destination terminal in case of a failure of the terminal. In step S315, the result of step S314 is determined whether the setting indicates that the terminal is to be converted or not. If the terminal is not to be switched, the process proceeds to step S322 where the command generating part 84 generates a command for informing of a failure of the terminal to the host computer 12. in step S323, the upper send buffer 74 sends the generated command to the upper I/F 72. In step S324, the command storage part resets the command stored therein. In step S313, the upper I/F 72 transmits the generated command to the host computer 12.

Referring again to step S315, if the terminal is to be switched, the process proceeds to steps S316. In step S316, the address analyzing part 86 checks the sender address and the destination address to be converted to. In step S317, the address converting part 88 converts the destination address by referring to the address table stored in the sub-address storage part 72. In step S318, the command generating part 84 generates a command stored in the command storage part 80 for the converted destination terminal. In step S318, the address switch informing part 94 generates destination address convert message to be sent to the manager terminal for informing that the destination address has been converted. In step S320, the send/receive buffer 98 sends the address convert message and the generated command to the lower I/F 100. In step S321, the lower I/F 100 sends the command and the message to LAN.

As has been described above, the data from the terminal is transmitted to the host computer with the address being converted by the communication apparatus 10. Further, In case of a failure of the terminal the communication apparatus 10 further performs processes such as transmitting data to an alternative terminal and informing the host computer 12 that the terminal has failed.

Further, the present invention is not limited to these embodiments, and variations and modifications may be made without departing from the scope of the present invention.

The present application is based on Japanese priority application No. 2001-394727 filed on Dec. 26, 2001, the entire contents of which are hereby incorporated by reference.

What is claimed is:

1. A communication apparatus for relaying a host device and a plurality of terminals, comprising:
first connection means which can be connected to said host device via a transmission line;
second connection means which can be connected to said plurality of terminals via a network; and
relaying means for relaying information received from said host device to said plurality of terminals, said information causing said plurality of terminals to perform predetermined processes.

2. The communication apparatus as claimed in claim 1, said information containing first destination information designating a destination terminal of said information,
said communication apparatus further comprising destination information converting means for replacing first destination information with second destination information so that that information containing said second destination information is transmitted to said destination terminal.

3. The communication apparatus as claimed in claim 2, wherein said first destination information is a logic name of said destination terminal and second destination information is a real address of said destination terminal.

4. The communication apparatus as claimed in claim 3, wherein said destination information converting means comprises a destination conversion table in which said first destination information is associated with said second destination information.

5. The communication apparatus as claimed in claim 4, said destination conversion table further includes third destination information,
wherein upon detection of a failure in a destination terminal designated by said second destination information, said destination information converting means converts said first destination information to said third destination information instead of said second destination information.

6. The communication apparatus as claimed in claim 4,
further comprising a terminal status monitoring means for monitoring the status of the terminal,
wherein said destination information converting means converts said first destination information to said third destination information instead of said second destination information according to the terminal status information obtained from said terminal status monitoring means.

7. The communication apparatus as claimed in claim 5,
further comprising first setting means for setting whether or not to perform a converting operation from said first destination information to said third destination information,
wherein said destination information converting means converts said first destination information to said third destination information in accordance with settings in said first setting means.

8. The communication apparatus as claimed in claim 5,
further comprising second setting means for setting third destination information,
said second setting means sets desired destination information as said third destination information.

9. The communication apparatus as claimed in claim 8, further comprising:
input means for inputting settings information used in said first setting means and said second setting means; and
display means for displaying settings information.

10. The communication apparatus as claimed in claim 8, wherein settings information that can be set by said first and second setting means are set via a terminal connected to said communication terminal and having input means for inputting settings information used in said first setting means and said second setting means and display means for displaying settings information.

11. The communication apparatus as claimed in claim 9, wherein said address converting means sends information which causes said display means to display a message indicating that said first destination information has been converted to said third destination information instead of said second destination information.

12. The communication apparatus as claimed in claim 2, further comprising:
information generating means for generating information which is recognizable by a destination terminal of said information on the basis of command information from said host device to said terminal.

13. The communication apparatus as claimed in claim 2, further comprising:
information analyzing means for analyzing information from said terminal, said information being transmitted to said terminal on the basis of a result obtained from said information analyzing means.

14. A communication method for relaying a host device and a plurality of terminals, said communication method comprising the steps of:
a) establishing a connection with said host device via a communication line;
b) establishing a connection with said plurality of terminals via a network; and
c) relaying information received from said host device to said plurality of terminals, said information causing said plurality of terminals to perform predetermined processes.

15. The communication method as claimed in claim 14, said information containing first destination information designating a destination terminal of said information,
said communication method further comprising the step of replacing said first destination information with second destination information, said information containing second destination information being transmitted to said destination terminal.

16. The communication method as claimed in claim 15, said first destination information being replaced with said third destination information instead of said second destination information.
